(19) United States
(12) Patent Application Publication
(10) Pub. No.: US 2002/0160091 A1
(43) Pub. Date: Oct. 31, 2002

(54) Acesulfame salt, process for its preparation and its use

(76) Inventor: Andreas Burgard, Frankfurt am Main (DE)

Correspondence Address: ProPat, L.L.C., 2912 Crosby Road, Charlotte, NC, 28211-2815, US

(21) Appl. No.: 10/131,650

(22) Filed: Apr. 24, 2002

(30) Foreign Application Priority Data
Apr. 26, 2001 (DE) 101 20 413.2

(51) Int. Cl. A23L 1/236

(52) U.S. Cl. 426/548

(57) ABSTRACT

The invention relates to a compound containing a nonmetal cation and an acesulfame anion, in which case, if appropriate, water of crystallization can additionally be present. As a nonmetal cation, the compound preferably contains an ammonium cation. The invention also relates to a process for preparing the inventive compound, and to its use for sweetening foods and drinks.

### BACKGROUND OF THE INVENTION

The known sweetener acesulfame (6-methyl-3,4-dihydro-1,2,3-oxathiazin-4-one 2,2-dioxide) has been used to date commercially predominantly as the potassium salt (acesulfame-K) for sweetening foods or dental and oral care products. The salts of acesulfame with alkali metals and alkaline earth metals are also known, for example with sodium, magnesium and calcium. These acesulfame-metal complexes are distinguished by a pleasantly sweet taste which is accompanied by an aftertaste dependent on the metal cation. These are defined compounds in which the metal is present as the cation and the acesulfame molecule as the anion.

In the event of certain disturbances of the electrolyte balance, hyperkalemia can occur, which is observed particularly frequently in patients having chronic and acute renal insufficiency, in particular in dialysis patients, in diabetics having renal insufficiency, in patients having hypoaldosteronism and in patients having Addison's disease. Hyperkalemia can also be drug-induced, due to potassium-retaining diuretics such as spironolactone, triamterene or amiloride, which lead to reduced renal excretion of potassium. Hyperkalemia can lead in extreme cases to neuromuscular problems and arrhythmias, for which reason a low-potassium diet is always indicated in the case of hyperkalemia.

However, diabetics having hyperkalemia due to renal insufficiency have to date only been able to use the potassium salt of acesulfame as a sweetener to replace carbohydrates in the diet which are harmful to them.

Replacing potassium in acesulfame-K by sodium is often undesirable, since, on account of some cardiovascular disorders, for example, hypertension, a low-sodium diet is indicated. Although acesulfame salts with alkaline earth metals, for example calcium or magnesium, taste sweet, because of their sweetness profile, due to a more or less metallic off-taste, they are not suitable alternatives for the potassium cation in the acesulfame salt. Other metal cations are excluded from the start because of their limited palatability.

It was therefore an object for the present invention to replace the potassium cation in the acesulfame salt by a pharmacologically and toxicologically safe cation, as far as possible by a nonmetal cation, without as a result impairing the taste and chemical properties that contribute to the commercial success of the compound acesulfame as a sweetener.

### BRIEF DESCRIPTION OF THE INVENTION

This object is achieved by a compound containing a nonmetal cation and an acesulfame anion, if appropriate in combination with water of crystallization.

### DETAILED DESCRIPTION OF THE INVENTION

The ammonium cation is known as a pharmacologically and toxicologically safe nonmetal cation. The Federal Drug Administration (FDA) has previously permitted various ammonium salts in the USA as food additives, for example ammonium bicarbonate, ammonium carbonate, ammonium chloride, ammonium hydroxide, and also monobasic and dibasic ammonium phosphate (Fed. Regist. 1983, 48, 224, 52438-40). In addition, ammonium glycyrrhizinate has long been used in foods as a sweetener (see M. K. Cook, Flavour Ind. 1970, 1, 12, 831-2).

Surprisingly, it has now been found that the acesulfame ammonium salt has exactly the same pleasant sweet taste as the acesulfame potassium salt. The acesulfame ammonium salt surprisingly has exactly the same sweetness profile and the same sweetening power as the acesulfame potassium salt. In the course of extensive taste tests, no difference was found by the testers between acesulfame ammonium and acesulfame potassium. Surprisingly, the acesulfame ammonium salt is neither salty-bitter, as is, for example, the ammonium chloride salt, nor is the acesulfame ammonium salt hygroscopic as is, for example, the ammonium acetate salt. The acesulfame ammonium salt thus surprisingly has the same desired properties with respect to its handling, its sweetening power and its taste profile as the acesulfame potassium salt. The acesulfame ammonium salt can therefore be used as a suitable alternative to the acesulfame potassium as a sweetener in a low-potassium diet necessitated by renal insufficiency.

For its preparation, the starting substance acesulfame-H, which denotes the acid corresponding to the acesulfame anion, and can be prepared by the process described in EP-A 0 155 634, is reacted with ammonia, which is introduced dissolved in a solvent, for example water or alcohol, to give the acesulfame ammonium salt in an acid-base reaction. In this case acesulfame-H as acid and ammonia as base react with one another. If water is used as solvent in the preparation, the acesulfame ammonium salt is isolated by crystallization after evaporating off the water. If an alcohol, in particular methanol or ethanol, is used as solvent, then when the acid acesulfame-H is added to the alcoholic ammonia solution, the acesulfame ammonium salt immediately crystallizes out and can be isolated by simple filtration.

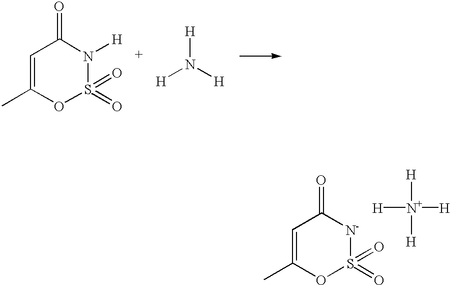

Alternatively, acesulfame-H can also be reacted with ammonium carbonate (NH₄)₂CO₃ or ammonium bicarbonate (NH₄)HCO₃ to give the corresponding acesulfame ammonium salt, in which case acesulfame-H reacts as acid and the carbonate or bicarbonate of the ammonium carbonate or ammonium bicarbonate reacts as base, forming CO₂.

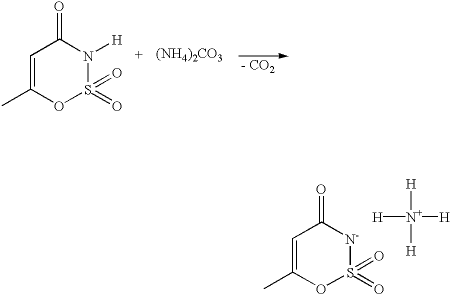

The crystal structure of the acesulfame ammonium salt was determined by X-ray structural analysis. The acesulfame ammonium salt consists of orthorhombic crystals, with the ammonium cation, as is the potassium cation in acesulfame-K (E. F. Paulus, Acta Cryst. 1975, B31, 11 91), being complexed by a negatively charged nitrogen atom of the acesulfame ligand, as shown below:

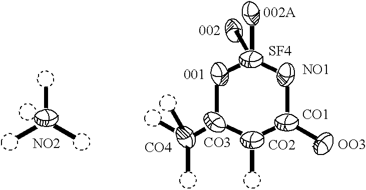

The invention will be described in more detail by the exemplary embodiments below.

### EXAMPLE 1

In a volume of 50 ml of distilled water, 100 mmol (16.3 g) of acesulfame-H were dissolved, a pH of 0.5 being established. To this solution was then added 25% strength ammonia water until a pH of 7.3 was established. The reaction mixture was then concentrated under reduced pressure. Colorless, non-hygroscopic crystals resulted, at a yield of 100%.

### EXAMPLE 2

100 mmol (16.3 g) of acesulfame-H were added to 100 ml of a 20% strength methanolic ammonia solution. The acesulfame ammonium salt crystallized out immediately in the form of colorless crystals which were separated from the methanolic ammonia solution by filtration.

The spectroscopic data of the acesulfame ammonium salt prepared in accordance with examples 1 and 2 were obtained as follows:

60-MHz-¹H—NMR (d₆-DMSO): δ(ppm)=2.1(s, 3H, CH₃), 5.6(s, 1H, CH), 7.5 (s,4H, ammonium)

1. A compound containing a nonmetal cation and an acesulfame anion.

2. A compound as claimed in claim 1, further containing water of crystallization.

3. A compound as claimed in claim 1 or 2, wherein the nonmetal cation is an ammonium cation.

4. A compound as claimed in claim 1 or 2, wherein it is an acesulfame ammonium salt, and its stoichiometric composition acesulfame:ammonium is in the range from 0.9 to 1.1.

5. A compound as claimed in claim 1 or 2, wherein it is an ionic compound.

6. A process for preparing a compound as claimed in claim 1 by reacting an acesulfame-H compound soluble in a solvent with the basic precursor of a nonmetallic cation.

7. The process as claimed in claim 6, wherein the precursor of a nonmetallic cation is ammonia or ammonium carbonate or ammonium bicarbonate.

8. The process as claimed in claim 6 or 7, wherein the solvent is water or a water-miscible organic solvent or water and a water-miscible organic solvent.

9. Sweetening food, containing a compound according to claim 1.

10. Drink, containing a compound according to claim 1.
